(19) United States
(12) Patent Application Publication
(10) Pub. No.: US 2008/0296114 A1
(43) Pub. Date: Dec. 4, 2008

(54) Clutch assembly for an override system of an automated barrier

(76) Inventor: Tai-Shan Chen, Hsin Chuang City (TW)

Correspondence Address: JACKSON WALKER, L.L.P., 112 E. PECAN, SUITE 2400, SAN ANTONIO, TX, 78205, US

(21) Appl. No.: 11/810,061

(22) Filed: Jun. 4, 2007

(51) Int. Cl. E01F 13/06; F16D 21/04

(52) U.S. Cl. 192/20; 404/6

(57) ABSTRACT

A clutch assembly for a motor of an automated barrier has a clutch and an override switch. The clutch is connected to the motor and has a body, an engaging frame, a cam segment and an engaging gear. The body is connected to the motor and has a cover, a mounting bracket and a pivot pin. The engaging frame is pivotally connected to the body and has a gudgeon, a rack lock and two elongated holes. The cam assembly is pivotally mounted in the engaging frame and to the body and has a cam block, two cam disks, a cable, a lobe and a pintle. The engaging gear is rotatably mounted in the body adjacent to the engaging frame. The override switch is connected to the clutch and has a casing, a switch mechanism and a switch spring.

### BACKGROUND OF THE INVENTION

1. Field of the Invention

The present invention relates to a clutch assembly, and more particularly relates to a clutch assembly for an override system of an automated barrier that allows the automated barrier to open easily and quickly without power.

2. Description of Related Art

With reference to FIGS. 10 and 11, a conventional automated barrier (60) in accordance with the prior art comprises two stanchions, a mounting box, a reel (62), a barrier and a motor (61).

Each of the stanchions has a top end and is mounted parallel to each other. The mounting box is connected transversely to the top ends of the stanchions and has a chamber and two sidewalls. The reel (62) is hollow, is rotatably connected to the mounting box in the chamber and has an outer surface, an inner surface, a proximal end, a distal end and an opening. The proximal end of the reel (62) is rotatably connected to one of the sidewalls of the mounting box. The opening is formed in the distal end of the reel (62).

The barrier is connected to the outer surface of the reel (62) and mounted around the reel (62) when the reel (62) rotating relative to the mounting box.

The motor (61) is connected to the mounting box and the reel (62), is used to rotate the reel (62) and has an inner end, an outer end, a drive gear (611), a transmitting gear (612) and a manual crank (613). The inner end of the motor (61) is extended into the reel (62) from the opening. The outer end of the motor (61) is connected securely to the other sidewall of the mounting box. The drive gear (611) is rotatably connected to the inner end of the motor (61) and abuts the inner surface of the reel (62). When the drive gear (611) is rotated by the motor (61), the reel (62) is rotated by the drive gear (611) relative to the mounting box to roll the barrier up or down. The transmitting gear (612) is mounted rotatably to the outer end of the motor (61) and is rotated with the drive gear (611).

The manual crank (613) is rotatably connected to the transmitting gear (612), is used to rotate the transmitting gear (612) and has a volute gear (614), a rotating rod and a cranking bar (615). The volute gear (614) is mounted in the outer end of the motor (61) below the transmitting gear (612), and engages with the transmitting gear (612). The rotating rod is connected to the volute gear (614), protrudes out of the mounting box and has a protruding end and a ring. The ring is formed on the protruding end of the rotating rod. The cranking bar (615) is connected detachably to the rotating rod, is used to rotate the reel (62) via the rotating rod, the volute gear (614), the transmitting gear (612) and the drive gear (611) and has a top end and a book. The hook is formed on the top end of the cranking bar (615) and is used to selectively engage the hook of the extending rod and allow manual operation.

When there is no power, a person can rotate the cranking bar (615) to rotate the extending rod, the volute gear (614), the transmitting gear (612) and the drive gear (611). Therefore, the reel (62) is rotated by the drive gear (611) and the barrier can be moved into the mounting box.

However, the conventional automated barrier (60) with the conventional motor (61) has the following shortcomings.

1. The transmitting gear (612) and the drive gear (611) may rotate with a circle when the volute gear (614) rotating several circles by the manual crank (613). This takes a lot of time opening or closing the barrier of the automated barrier (60).

2. During a fire, accident or a power cut, a person cannot open or close the barrier quickly and easily, and this reduces the safety of using the conventional automated barrier (60).

To overcome the shortcomings, the present invention provides a clutch assembly for a motor to mitigate or obviate the aforementioned problems.

### SUMMARY OF THE INVENTION

The main objective of the present invention is to provide a clutch assembly for an override system of an automated barrier that allows the automated barrier to open easily and quickly without power.

The clutch assembly for a motor of the override system has a clutch and an override switch. The clutch is connected to the motor and has a body, an engaging frame, a cam segment and an engaging gear. The body is connected to the motor and has a cover, a mounting bracket and a pivot pin. The engaging frame is pivotally mounted in the body and has a gudgeon, a rack lock and two elongated holes. The cam segment is pivotally mounted in the engaging frame and to the body and has a cam block, two cam disks, a cable, a lobe and a pintle. The engaging gear is rotatably mounted in the body over the engaging frame. The override switch is connected to the clutch and has a casing, a switch mechanism and a switch spring.

Other objectives, advantages and novel features of the invention will become more apparent from the following detailed description when taken in conjunction with the accompanying drawings.

### BRIEF DESCRIPTION OF THE DRAWINGS

FIG. 1 is a rear view in partial section of an override system for an automated barrier in accordance with the present invention;

FIG. 2 is an enlarged exploded perspective view of a clutch assembly of the motor in FIG. 1;

FIG. 3 is an exploded perspective view of the clutch of the clutch assembly for the motor in FIG. 2;

FIG. 4 is an operational side view in partial section of engaged internal elements of the clutch assembly in FIG. 2;

FIG. 5 is an exploded perspective view of a second embodiment of a motor of an automated barrier in accordance with the present invention;

FIG. 6 is a perspective view of a switch for the clutch assembly for the motor in FIG. 2;

FIG. 7 is an exploded perspective view of the internal elements of the switch in FIG. 6;

FIG. 8 is an operational exploded perspective view of the internal elements of the switch in FIG. 6;

FIG. 9 is an operational side view in partial section of disengaged internal elements of the clutch of the clutch assembly in FIG. 4;

FIG. 10 is a rear view in partial section of a conventional automated barrier in accordance with the prior art; and

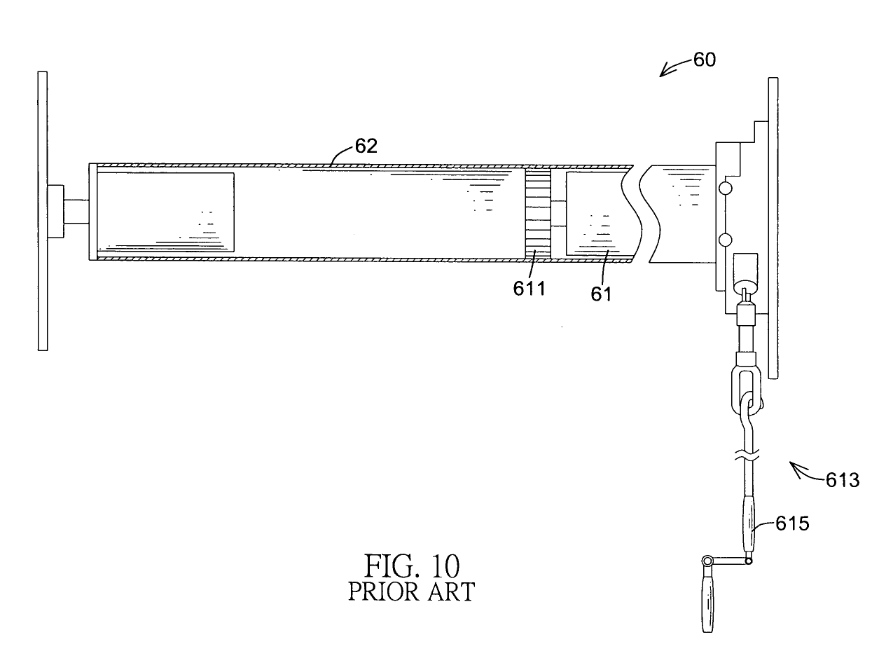

FIG. 11 is an operating side view of internal elements of the conventional automated barrier in FIG. 10.

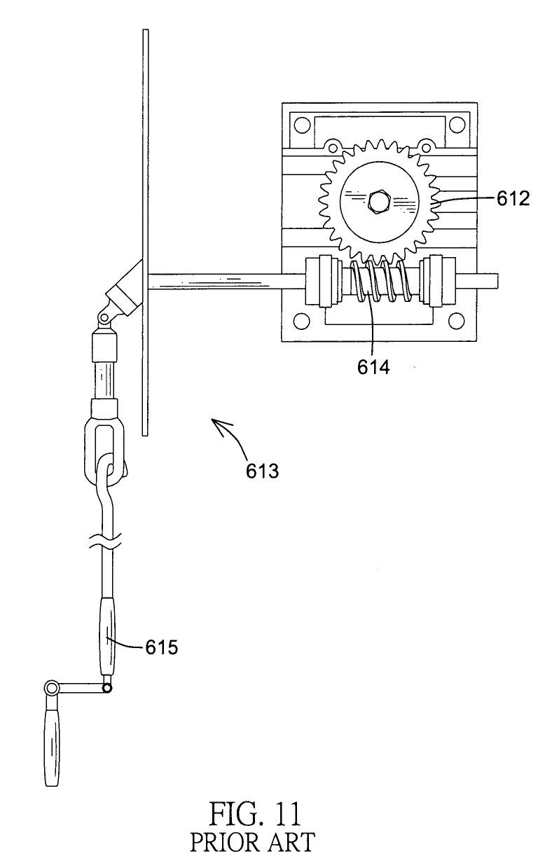

### DETAILED DESCRIPTION OF THE PREFERRED EMBODIMENT

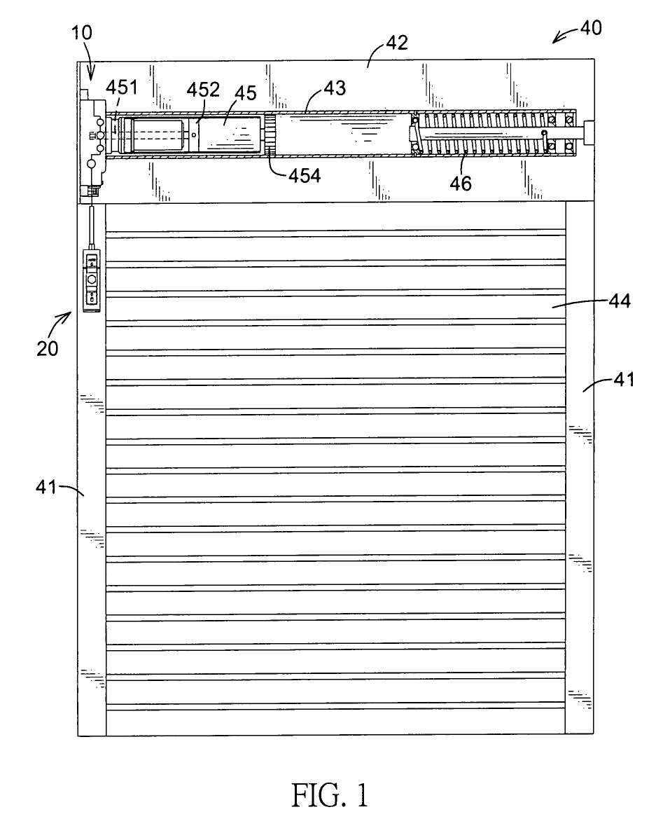

With reference to FIG. 1, a clutch assembly for an override system of an automated barrier (40) in accordance with the present invention having two stanchions (41), a mounting box (42), a reel (43) and a barrier (44). The clutch assembly is connected to the automated barrier (40) and has a clutch (10) and an override switch (20). The stanchions (41) are mounted vertically and parallel to each other and each stanchion (41) has a top end.

The mounting box (42) is connected transversely to the top ends of the stanchions (41) and has a chamber and a motorized sidewall and a mounting sidewall that are aligned on a longitudinal axis.

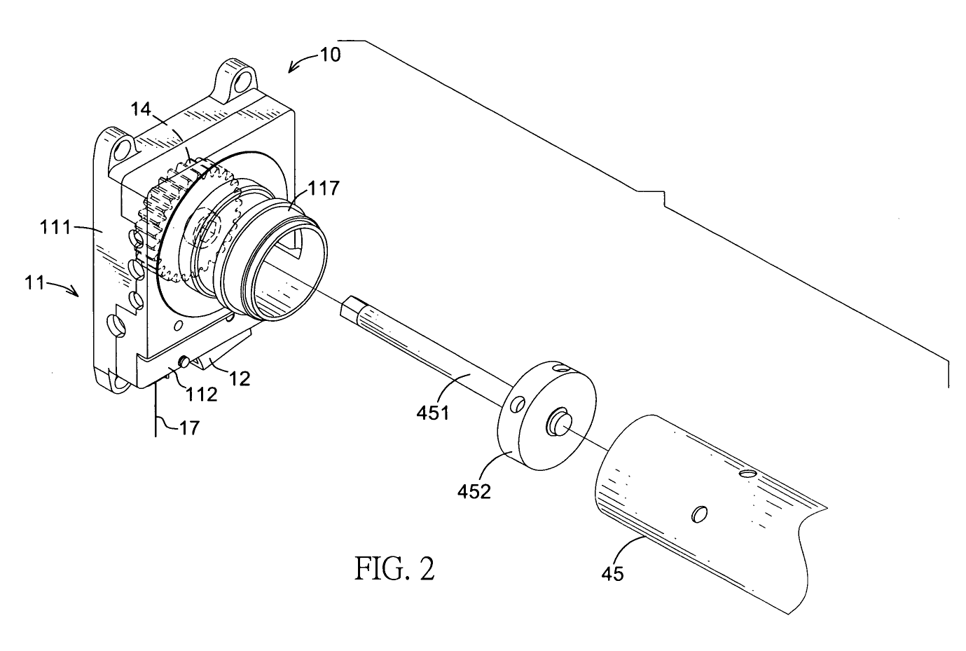

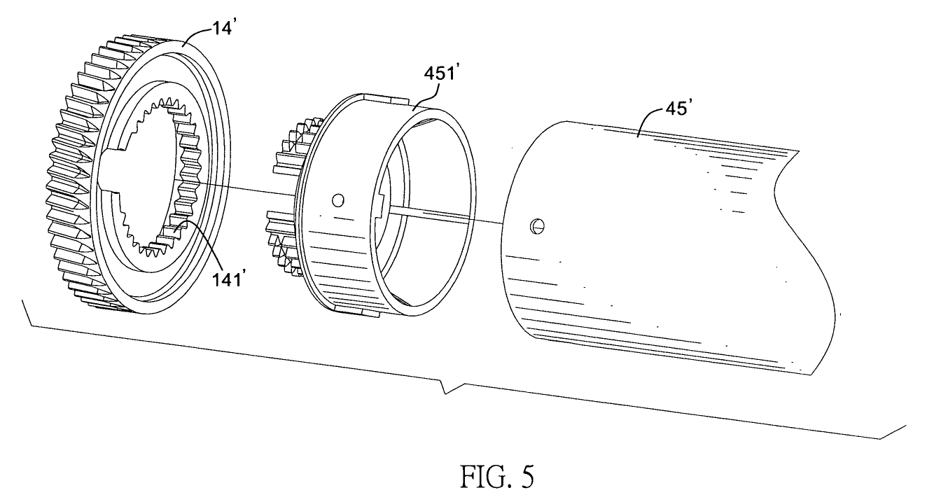

With further reference to FIGS. 2 and 5, the reel (43) is hollow, is rotatably mounted in the chamber of the mounting box (42) and has an outer surface, an inner surface, a distal end, a proximal end, a spring assembly (46) and a motor (45, 45′).

The spring assembly (46) is connected to the distal end of the reel (43) has a rotating axle and a drive spring mounted on the longitudinal axis. The rotating axle is mounted longitudinally to the mounting sidewall of the mounting box (42), and extends into the distal end of the reel (43). The drive spring is mounted around the rotating axle and rotates the reel (43) relative to the mounting box (42).

The motor (45, 45′) is mounted in the reel (43) from the proximal end and has an inner end, an outer end, a cavity, an inner surface a drive gear (454) and a clutching member. The outer end of the motor (45, 45′) protrudes out of the proximal end of the reel (43) towards the mounting end of the mounting box (42). The inner end of the motor (45, 45′) lies on the opposite, on the longitudinal axis aligned with the spring assembly (46) and the rotating axle. The drive gear (454) is rotatably connected to the inner end of the motor (45, 45′) and abuts the inner surface of the reel (43). The clutch member is mounted on the outer end of the motor (45, 45′). The clutch member may be a shaft clutch (451) or a gear clutch (451′).

The shaft clutch (451) comprises a disc (452) mounted on the outer end of the motor (45) with a shaft that is formed on and protrudes from the disc (452) along the longitudinal axis of the mounting box (42) and has a keyed end. The gear clutch (451′) is mounted on the outer end of the motor (45) and has a gear wheel protruding transversely to the longitudinal axis of the mounting box (42)

The barrier (44) is mounted to the outer surface of the reel (43). The motor (45, 45′) forces the drive gear (454) to rotate and turns the reel (43) relative to the mounting box (42) to roll the barrier (44) into an up position and a down position. The up and down positions are respectively an open and closed aperture.

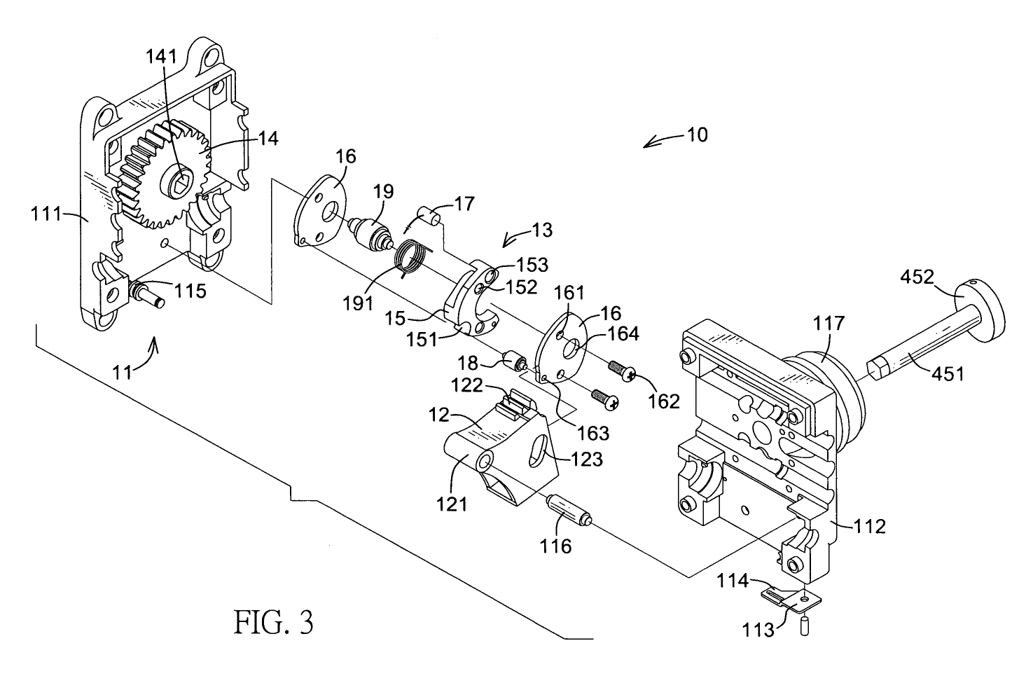

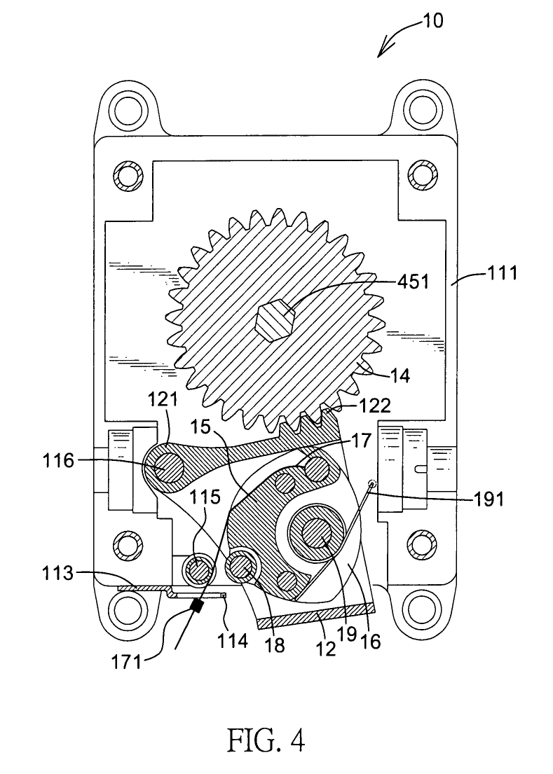

With further reference to FIGS. 3, 4 and 6, the clutch assembly is connected to the motor (45, 45′) by a shaft clutch (451) or a gear clutch (451′) and has a clutch (10) and an override switch (20). The clutch (10) has a body (11), an engaging frame (12), a cam assembly (13) and an engaging gear (14, 14′).

The body (11) may be hollow, is connected to the motor (45, 45′) by the shaft clutch (451) or the gear clutch (451′) and is mounted on the motorized sidewall of the mounting box (42) and comprises a cover (112), a mounting bracket (111), a bottom, a bottom through hole, a guiding plate (113), an idler (115) and a pivot pin (116).

The cover (112) is mounted on the mounting bracket (111) and around the clutch member and has a top, a bottom, a front side, an external surface, an internal surface and an extending sheath (117). The external surface abuts the proximal end of the reel (43). The extending sheath (117) is formed on and protrudes from the external surface of the cover (112) and is mounted inside the reel (43).

The mounting bracket (111) corresponds to the cover (112) and is mounted in the mounting box (42) and has a top, a bottom, a front side, an internal surface and an external surface. The internal surface of the mounting bracket (111) is aligned with the internal surface of the cover (112) to form the bottom through hole through the bottom of the body (11). The external surface of the mounting bracket (111) is connected securely to the mounting sidewall of the mounting box (42).

The guiding plate (113) is mounted on the bottom of the body (11) near the front side and has a through hole (114) and a bottom. The through hole (114) is formed through the guiding plate (113) and communicates with the space between the cover (112) and the mounting bracket (111).

The idler (15) is mounted transversely to the cover (112) and the mounting bracket (111) above the guiding plate (113).

The pivot pin (116) is mounted transversely from the cover (112) to the mounting bracket (111) above the idler (115).

The engaging frame (12) may be a trapezoid, is rotatably mounted on the pivot pin (116), in relation to the mounting box (42) and has, a top, a bottom, two side surfaces, a front surface, a gudgeon (121), a rack lock (122) and two elongated holes (123). The gudgeon (121) is formed transversely on the front surface of the engaging frame (12) and is mounted on the pivot pin (116). The rack lock (122) is formed on the top of the engaging frame (12) opposite the gudgeon. The elongated holes (123) are respectively formed through the side surfaces of the engaging frame (12).

The cam assembly (13) is pivotally mounted to the mounting bracket (111) and in the engaging frame (12) and may have a cam block (15), two cam disks (16), a cable (17), a lobe tube (18) and a pintle (19).

The cam block (15) may be C-shaped, is pivotally mounted in the engaging frame (12) and to the body (11) and has a top end, a bottom end, a middle, two sides, a mounting recess (151), multiple mounting holes (152) and a cable mount (153). The mounting recess (151) is formed through the cam block (15) near the middle. The mounting holes (152) are formed through the cam block (15) between the top end and the bottom end. The cable mount (153) is formed through the top end of the cam block (15).

The cam disks (16) are respectively connected to the sides of the cam block (15) and each cam disk (16) has multiple connecting holes (161), multiple connecting pins (162), a lobe mounting hole (163) and a pivot hole (164). The connecting holes (161) are formed through the cam disk (16) and align with the mounting holes (152) in the cam block (15). The connecting pins (162) are respectively mounted through the connecting holes (161) in the cam disk (16) and the corresponding mounting holes (152) in the cam block (15) to form the cam assembly (13). The lobe mounting holes (163) is formed through the cam disks (16) and are aligned with the mounting recess (151) in the cam block (15).

The pivot hole (164) is formed through the cam assembly (13) and is aligned with the elongated holes (123) in the engaging frame (12).

The cable (17) is connected to the top of the cam block (15) and abuts the idler (115) and has a switch end and a retaining bar (171). The switch end of the cable (17) extends out the body (11) through the through hole (114) in the guiding plate (113) and the retaining bar (171), is mounted around the cable (17) and selectively abuts the bottom of the guiding plate (113).

The lobe tube (18) is mounted in the mounting recess (151) of the cam block (15) and has two ends mounted respectively in the lobe mounting holes (163) in the cam disks (16).

The pintle (19) is mounted through the pivot holes (164) of the cam disks (16) and the elongated holes (123) of the engaging frame (12) and may have a pivotal spring (191). The pivotal spring (191) is mounted around the pivot post (19) between the cam disks (16) and has two connecting ends mounted respectively to the cover (112) and the cam block (15).

With reference to FIGS. 3 and 5, the engaging gear (14, 14′) is rotatably mounted in the body (11), may be mounted between the cover (112) and the mounting bracket (111) adjacent to the engaging frame (12) and has a center, a keyed surface (141, 141′) and multiple outer teeth. The keyed end of the shaft clutch (451) or the gear clutch (451′) is mounted in the keyed surface (141, 141′) formed at the center of the engaging gear (14,14′). The outer teeth are formed around the engaging gear (14, 14′) and engage with the rack lock (122) at the top of the engaging frame (12). The engaging gear (14) has a mounting hole formed through the center.

When a shaft clutch (451) is used, the keyed end of the shaft is mounted in the keyed surface (141) of the engaging gear (14). When a gear clutch (451′) is used, the keyed surface of the engaging gear (14′) comprises multiple inner teeth (141′). The connecting teeth of the gear clutch (451′) are mounted, and engage with the inner teeth (141′) of the engaging gear (14′).

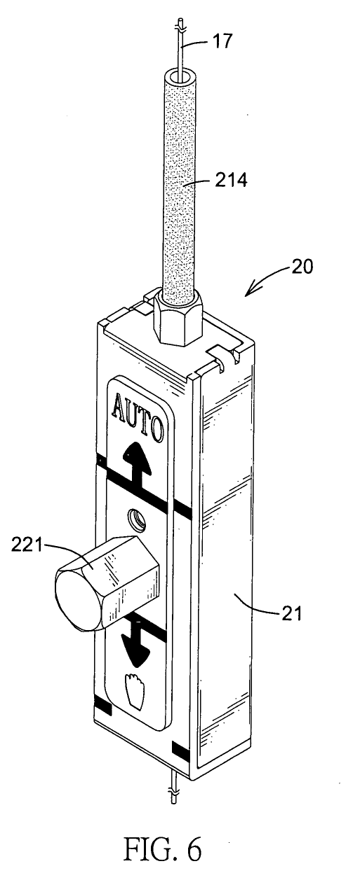

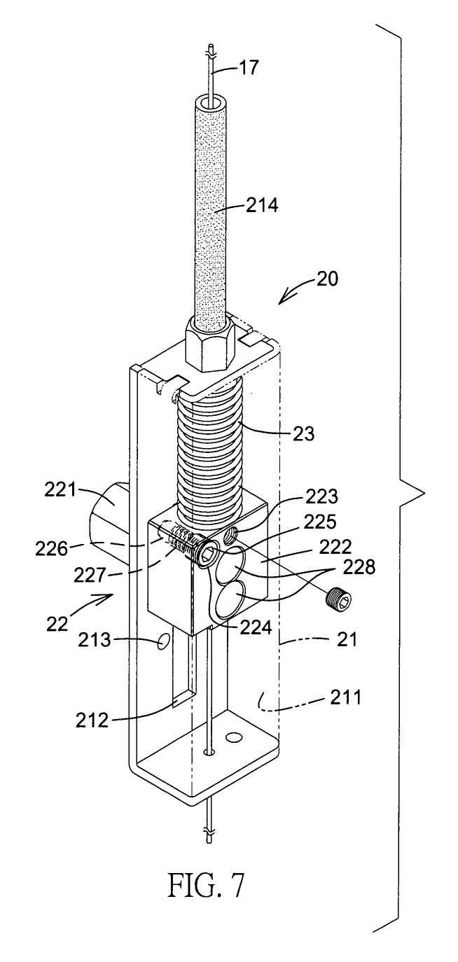

With reference to FIGS. 6 and 7, the override switch (20) is connected to the clutch (10), may be by the cable (17) reeved in a cableway and may have a casing (21), a switch mechanism (22) and a switch spring (23). The casing (21) is attached to one of the stanchions (41) and has a rear side, a front side, a top, a chamber (211), an opening (212), a manual and an automatic detents (213) and a cableway (214). The rear side of the casing (21) is connected to the corresponding stanchion (41). The front side of the casing (21) is aligned parallel to the rear side and has an internal surface. The opening (212) is formed through the front side of the casing (21) and communicates with the chamber (211). The detents (213) are formed in the internal surface of the front side and are aligned in line near the opening (212). The cableway (214) is connected vertically to the top of the casing (21) and communicates with the chamber (211) and the switch end of the cable (17) extends into the chamber (211) via the cableway (214).

The switch mechanism (22) is movably connected to the casing (21), is connected to the cam assembly (13) and has a handle (221) and a switch block (222).

The handle (221) may be T-shaped, is movably connected to the front side of the casing (21) and has an inner side.

The switch block (222) is connected securely to the handle (221) in the chamber (211) of the casing (21) and has a top, a front side, a rear side, two handle mounting holes (228), a threaded hole (223), a detent ball hole (224), a fastener (225), a detent ball (226) and a detent ball spring (227).

The front side of the switch block (222) is aligned with the inner side of the handle (221) via the opening (212).

The handle mounting holes (228) are formed through the switch block (222) and communicates with the opening (212). Bolts extend into the handle mounting holes (228) and are connected to the inner side of the handle (221). Therefore, the switch block (222) can be moved up and down along the opening (212) by the handle (221).

The threaded hole (223) is formed through the switch block (222) above the handle mounting holes (228). The switch end of the cable (17) extends into the threaded hole (223) and is connected to the switch block (222) by a bolt.

The detent ball hole (224) is formed through the switch block (222) near the threaded hole (223), and is selectively aligned with the manual and automatic detents (213). The detent ball (226) is mounted freely in the detent ball hole (224) and the corresponding detent (213) in the casing (21) and is held in place by the fastener (225). The detent ball spring (227) is mounted in the detent ball hole (224) between the fastener (225) and the detent ball (226).

The switch spring (23) is mounted in the chamber (211) of the casing (21) between the tops of the casing (21) and the switch block (222).

When the handle (221) of the override switch (20) is moved to a manual position, the detent ball (226) is forced into the manual detent (213), holding the switch block (222) in place and pulling the cable (17) away from the clutch assembly. Similarly, when the handle (221) of the switch (20) is moved to an automatic position, the detent ball (226) is forced into the automatic detent (213), holding the switch block (222) in place and allowing the cable (17) to return into the clutch assembly (10).

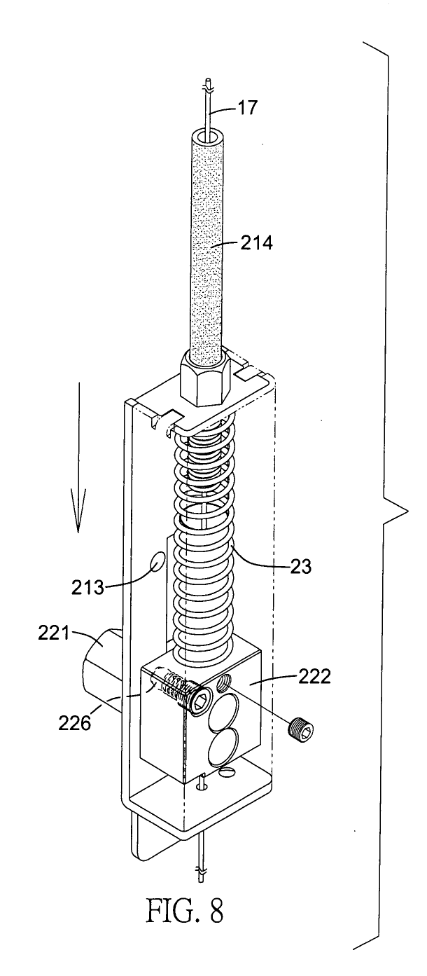

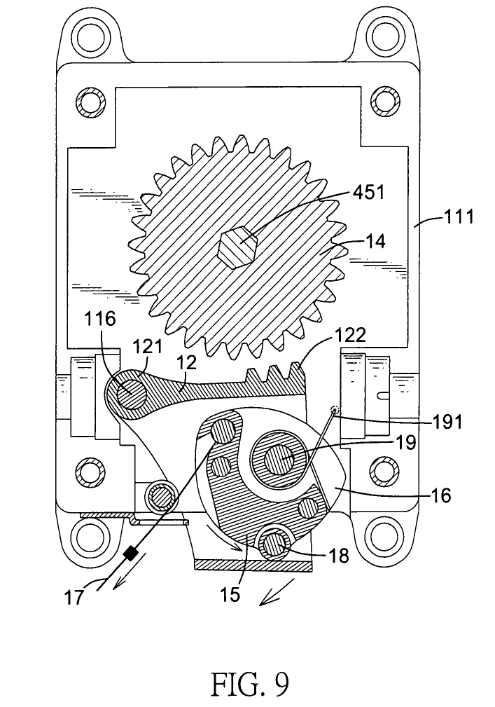

With further reference to FIGS. 8 and 9, during a fire, accident or a power failure, a person can position the override switch (20) in manual. Consequently, switch block the cam assembly (13) rotates relative to the engaging frame (12). With the rotating of the cam assembly (13), the lobe tube (18) will abut and move the bottom of the engaging frame (12), causing the rack lock (122) to disengage the outer teeth of the engaging gear (14, 14′). Therefore, the person can push the barrier (44) up and into the mounting box (42), helped by the spring assembly (46) quickly and easily.

When the power supply is active, a person can position the override switch (20) in automatic and moving the cable (17) by the pivotal spring (191) and make the cam assembly (13) to rotate relative to the engaging frame (12) causing the rack lock (122) to engage with the engaging teeth or the outer teeth of the engaging gear (14, 14′). Then, the person can move the barrier (44) up and down with the motor (45, 45′).

The clutch assembly for an automated barrier motor as described has the following advantages.

1. With the arrangements of the engaging gear (14, 14′) and the cam assembly (13), the barrier (44) can be pushed up and down with the reel (43) in a manual situation or during regular power-driven usage.

2. When a fire accident or a power failure, a person can open or close the barrier (44) quickly and easily by pushing the handle (221) down to release the rack lock (122) automated barrier and open the door without using a time consuming hand crank.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A clutch assembly for an override system of an automated barrier comprising
a clutch being adapted to connect to the automated barrier and having
a body having a pivot pin being mounted transversely in the body;
an engaging frame being pivotally mounted on the pivot pin and having
a top;
a bottom;
two side surfaces;
a gudgeon being formed transversely on the top of the engaging frame and being mounted around the pivot pin;
a rack lock being formed on the top of the engaging frame opposite the gudgeon; and
two elongated holes being respectively formed through the side surfaces of the engaging frame;
a cam assembly being pivotally mounted in the engaging frame and to the body; and
an engaging gear being rotatably mounted in the body adjacent to the engaging frame and having;
a keyed surface formed at a center; and
multiple outer teeth selectively engaging the rack lock; and
an override switch being connected to the clutch and having
a casing; and
a switch mechanism being movably connected to the casing and being connected to the cam assembly.

2. The clutch assembly for an override system of an automated barrier as claimed in claim 1, wherein the body further is hollow and has
a bottom;
a bottom through hole;
a cover being adapted to connect to the automated barrier and having
a top;
a bottom;
a front side;
an external surface;
an internal surface; and
an extending sheath being formed on and protruding from the external surface of the cover and being adapted to be mounted inside the automated barrier; and
a mounting bracket corresponding and attaching to the cover and having
a top;
a bottom;
a front side;
an internal surface being aligned with the internal surface of the cover to form the bottom through hole; and
an external surface.

3. The clutch assembly for an override system of an automated barrier as claimed in claim 2, wherein the cam assembly further has
a cam block being pivotally mounted in the engaging frame and the body and having
a top end;
a bottom end;
a middle;
two sides;
a mounting recess being formed through the cam block near the middle; and
a cable mount being formed through the top end of the cam block;
two cam disks being respectively connected to the sides of the cam block and each cam disk having
a lobe mounting hole being formed through the cam disk and being aligned with the mounting recess in the cam block; and
a pivot hole being formed through the cam disk and being aligned with the elongated holes in the engaging frame;
a cable being attached to the cam block and having a switch end extending out of the body;
a lobe tube being mounted in the mounting recess of the cam block and having two ends being connected respectively to the lobe mounting holes in the cam disks; and
a pintle being mounted through the pivot holes of the cam disks and having two ends being respectively mounted through the elongated holes in the engaging frame.

4. The clutch assembly for an override system of an automated barrier as claimed in claim 3, wherein
the body further has
a guiding plate being connected to the bottom of the body near the front side and having a through hole being formed through the guiding plate and communicating with a space between the cover and the mounting bracket; and
an idler being connected transversely from the cover to the mounting bracket above the guiding plate; and
the cable abuts the idler and has a retaining bar being mounted around the cable and abutting against the guiding plate.

5. The clutch assembly for an override system of an automated barrier as claimed in claim 4, wherein
the casing has
a rear side;
a front side being aligned parallel to the rear side and having an internal surface;
a top;
a chamber;
an opening being formed through the front side of the casing and communicating with the chamber;
two detents being a manual and an automatic detents formed on the internal surface of the front side and being aligned in line near the opening; and
a cableway being connected to the top of the casing and communicating with the chamber; and
the switch mechanism has
a handle being movably connected to the front side of the casing and having an inner side; and
a switch block being connected securely to the handle in the chamber of the casing and having
a top;
a front side being aligned with the inner side of the handle through the opening;
a rear side;
a handle mounting hole being formed through the switch block near the top and communicating with the opening;
a threaded hole being formed through the switch block above the handle mounting hole and the switch end of the cable extending into the threaded hole;
a detent ball hole being formed through the switch block near the threaded hole, and being selectively aligned with the detents;
a fastener being screwed with the detent ball hole opposite the detents in the casing;
a detent ball being mounted freely in the detent ball hole and one of the detents in the casing; and
a detent ball spring being mounted in the detent ball hole between the fastener and the detent ball;
wherein the switch end of the cable extends into the chamber via the cableway.

6. The clutch assembly for an override system of an automated barrier as claimed in claim 5, wherein the pintle has a pivotal spring being mounted around the pintle between the cam disks, and has two connecting ends mounted to the cover and the cam block.

7. The clutch assembly for an override system of an automated barrier as claimed in claim 6, wherein
the cam block has multiple mounting holes being formed through the cam block between the top end and the bottom end; and
each cam disk has
multiple connecting holes being formed through the cam disk and aligning with the mounting holes in the cam block; and
multiple connecting pins being respectively mounted through the connecting holes in the cam disk and the mounting holes in the cam block to connect the cam disk with the cam block in the engaging frame.

8. The clutch assembly for an override system of an automated barrier as claimed in claim 7, wherein the override switch further has a switch spring being mounted in the chamber of the casing between the tops of the casing and the switch block.

9. The clutch assembly for an override system of an automated barrier as claimed in claim 8, wherein the engaging gear has
a center;
multiple inner teeth being formed around the center of the engaging gear; and
multiple outer teeth being formed around the engaging gear and being engaged with the rack lock on the engaging frame.

10. The clutch assembly for an override system of an automated barrier as claimed in claim 8, wherein the engaging gear has
a center;
a mounting hole being formed through the center of the engaging gear; and
multiple engaging teeth being formed around the engaging gear and being engaged with the rack lock on the top of the engaging frame.

11. The clutch assembly for an override system of an automated barrier as claimed in claim 8, wherein the engaging frame is a trapezoid.

12. The clutch assembly for an override system of an automated barrier as claimed in claim 11, wherein the cam block is C-shaped.

13. The clutch assembly for an override system of an automated barrier as claimed in claim 12, wherein the handle is T-shaped in cross section.
